(19) United States
(12) Patent Application Publication
(10) Pub. No.: US 2012/0090230 A1
(43) Pub. Date: Apr. 19, 2012

(54) Collapsible expandable plant support

(76) Inventors: Debbie Frost, Griffin, GA (US); Lawrence Arthur Frost, Griffin, GA (US)

(21) Appl. No.: 12/925,185

(22) Filed: Oct. 15, 2010

(51) Int. Cl. A01G 9/12; A01G 1/00

(52) U.S. Cl. 47/45; 47/58.1 R

(57) ABSTRACT

In accordance with one embodiment a collapsible, expandable, configurable plant apparatus comprises a plurality of panels having a planar configuration with an upper edge, a base edge, side edge one (17), side edge two (18), and at least one lower limb (13), to accommodate use by a plant for support. The lower limb (13) supports the frame in a vertical orientation to the ground. The upper edge connects to the side edges (17 and 18), and the base edge connects to the side edges (17 and 18). Side edges (17 and 18) pivotally connect to one another having the end side edge (17) of the first panel and the end side edge (18) of the last panel of the plant support left unattached. The panels move individually to configure from a compact storage state to extend out to create support for a plant when in expanded state and a closed state. Such that the apparatus can accommodate use by a plant for support within and alongside the apparatus.

### CROSS-REFERENCE TO RELATED APPLICATIONS

“Not Applicable”

### FEDERALLY SPONSORED RESEARCH

“Not Applicable”

### SEQUENCE LISTING OR PROGRAM

“Not Applicable”

### FIELD OF INVENTION

The present invention relates to plant supports, and more particularly, to a collapsible, expandable, configurable, plant support apparatus.

### BACKGROUND OF THE INVENTION

The following is a tabulation of some prior art that presently appears relevant:

U.S. Patents

| Pat. No. | Issue Date | Patentee |
|---|---|---|
| 1,361,464 | Dec. 07, 1920 | Hunt |
| 4,019,280 | Apr. 26, 1977 | Summers |
| 4,503,636 | Mar. 12, 1985 | Stuckey |
| 6,088,956 | Jul. 18, 2000 | Rocka |
| 5,179,799 | Jan. 19, 1993 | Hilistead |
| 4,005,548 | Feb. 01, 1977 | Nahon |
| 4,285,163 | Aug. 25, 1981 | Booker |
| 4,073,091 | Feb. 14, 1978 | Vogel |
| 3,793,771 | Feb. 26, 1974 | Slaughter |
| 6,453,606 | Sep. 24, 2002 | Shulman |
| 5,544,446 | Aug. 13, 1996 | Benson |

### DESCRIPTION OF BACKGROUND OF THE INVENTION

Garden centers, nurseries, and localized farm stores commonly sell many different types of devices for supporting growing plants. In today's society both the hobby gardener and the professional gardener alike have requirements for a plant support device that differ from their predecessors.

The industry has been motivated to develop a variety of plant supports to address simplicity, ease of use, durability, broad application and efficient storage.

Originally, driving a stake into the ground next to each plant supported plants. As the plant grows, the stem is tied loosely to the stake with soft twine or cloth strips. However, gardeners objected since this consumed a fair amount of time and labor:
(a) the tall growing tomato plants required being tied several times without damaging the plant,
(b) damage to the plant roots occurred if the stake was driven in the ground after the plant had started to grow.

Many of the prior art plant supports are not collapsible. The typical cone-shaped tomato cage is the most common sold on the market. One common design includes a plurality of elongate rods and a plurality of rings, all made of metal. The rings are coaxial and vertically spaced from one another and secured to the rods. Often, the diameter of the rings decreases going from the highest ring to the lowest ring. Inserting the rods into the ground surrounding the roots of the tomato plant uses such a tomato cage. As the plant grows it becomes top heavy and falls over. Thereby, once touching the ground, the fruit or vegetable will begin to spoil, wasting money and time spent growing the plant.

Such a cage design does not satisfy the basic requirement of supporting the plant. In addition, any particular cage that is fixed in size cannot adapt to variations in plant size, the growth of the plant or the like. While different cage sizes can be made available, it is difficult to change the cage with a mature plant. In addition, the wires are lightweight and difficult to push into the soil.

Efforts have been made by inventors to design a plant support device that serves to support the plants and occupy less storage space. One of the early designs Hunt, U.S. Pat. No. 1,361,464 (1920), comprises a triangular arrangement of the upright support stakes. Hunt's apparatus cannot be folded over on one another without removing various pivot pins in the hinges used to interconnect the triangular configuration of upright stakes. Summers, U.S. Pat. No. 4,019,280 (1988), comprises collapsing of the plant support for storage by first pulling the legs from the ground thereby releasing the rings which are then disconnected at their ends.

Stuckey, U.S. Pat. No. 4,503,636 (1985), the rings are detachable leaving parts to be stored. Rocka, U.S. Pat. No. 6,088,956 (2000), a hub member and an axle member rotate connecting members permitting them to fold. Hilistead, U.S. Pat. No. 5,179,799 (1993), the apparatus is readily disassembled for storage, but requires breaking the support down into its separate component parts.

Nahon, U.S. Pat. No. 4,005,548 (1977), employs a plurality of upright rods and cross wires, which may be assembled by the end-user in order to provide the erected support structure. However, after use, this structure requires substantial disassembly before it can be stored in a compacted configuration. Each invention has a fixed area forming a fixed cage, and cannot be changed either at the start of the growing season or during the growing season to accommodate plant growth. Each invention has parts that must be removed to break down for storage.

Many of the prior art collapse. Booker, U.S. Pat. No. 4,285,163 (1981), has two sides having less than the remaining two adjacent sides of the structure. Vogel, U.S. Pat. No. 4,073,091 (1978) is another four-sided plant support having staking means that are integral in the support that is foldable. Slaughter, U.S. Pat. No. 3,793,771, (1974), has an inverted U having hinges that enable the members to be folded together side by side having a vertical section of mesh secured to the front face of each of the members. Shulman, U.S. Pat. No. 6,453,606 (2002) has vertical members connected to a plurality of rings by guide hubs on the vertical members, thusly providing the collapsible feature of the structure.

Each of the systems mentioned is fixed in size and cannot adapt to variations in plant size, the plant growth, and the like, at the start of the growing season or during the growing season. The support systems cannot be adjusted to a larger or smaller area during the growing season. Each of these support systems are such that they must be put into use while the plant is young. Otherwise, using these systems during later growth stages proves to be difficult and results in damage to the plant, stems, and fruit.

Benson, U.S. Pat. No. 5,544,446 (1996), is a collapsible and adjustable plant support utilizing lattice and a hinge mechanism to be used in a straight open configuration or used to enclose any desired area from nearly circular to rectangular. However, staking the support to the ground requires separate elements. Putting the apparatus in use is cumbersome and time consuming. In addition, the rings permit the connected sections to slide, causing them to be offset and difficult to work with.

All of the plant support designs heretofore known suffer from a number of disadvantages:
(a) Plant supports in present use having a fixed area forming a fixed cage cannot be changed either at the start of the growing season or during the growing season to accommodate plant growth.
(b) Plant supports in present use having a fixed area forming a fixed cage cannot be coupled to a second assembly to increase area of support needed.
(c) Plant supports of present use having separate parts, such as poles, legs, and rings, can become separated or lost.
(d) Plant supports made of thin wire bend under the weight of the plant as it matures and are difficult to push into the soil.
(e) Having to break the collapsible support down into separate component parts in order to disassemble for storage can take up valuable time.
(f) Plant support systems that are neither foldable nor collapsible require lots of storage space.

### SUMMARY

In accordance with one embodiment a collapsible, expandable, configurable plant support apparatus comprises a plurality of panels having a planar configuration with an upper edge, a base edge, two side edges, and at least one lower limb, to accommodate use by a plant for support. The lower limb supports the frame in a vertical orientation to the ground. The upper edge connects to the side edges, and the base edge connects to the side edges. The side edges pivotally connect to one another having the end side edge of the first panel and the end side edge of the last panel left unattached. The panels move individually to configure from a compact storage state to extend out to create support for a plant when in an expanded state and a closed state. Such that the apparatus can accommodate use by a plant for support within and alongside the apparatus. In addition, the plant support apparatus can be attached to more than one additional plant support.

### Advantages

In view of the above, there is still the need in the field for alternative plant support systems that combine the benefits of having simple, integrated structural components. Accordingly several advantages of one or more aspects are as follows: to provide a support structure that is easily erected for use; that can be used outdoors or indoors, that is easily compacted flat for storage; that can provide physical support throughout the growing season; that can configure from a compact storage state to extend out to create support for a plant when in expanded state and a closed state; that can maneuver to an open position to gain easy access to the plant within enclosed apparatus; and that can be connected to more than one additional plant support. Other advantages will be apparent from a consideration of the drawings and ensuing description.

### DRAWINGS

### Figures

In the drawings, closely related figures have the same number but different suffixes.

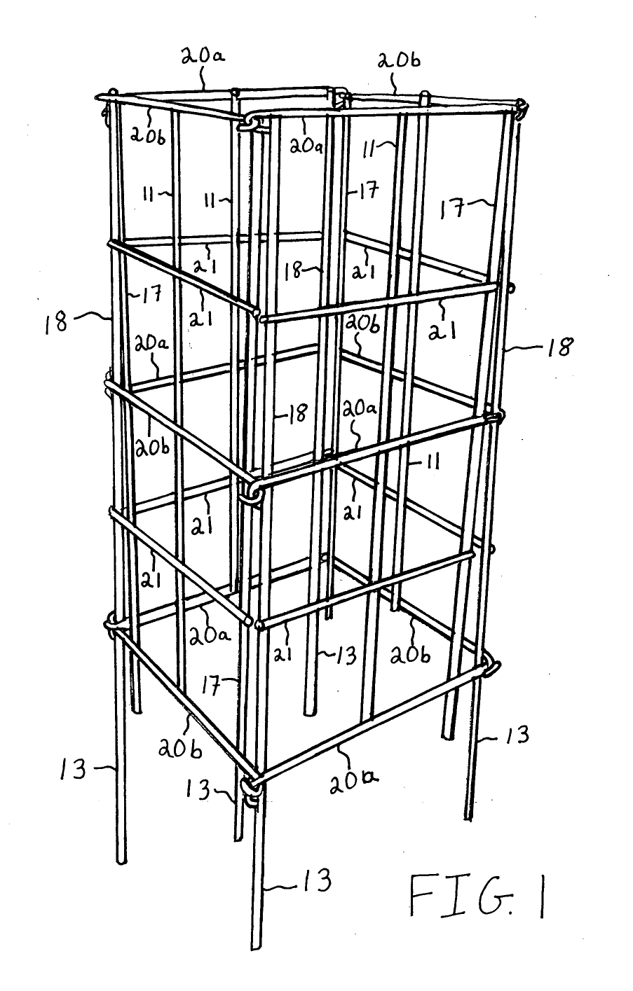

FIG. 1 illustrates a front view of the plant apparatus expanded to a closed state in accordance with one embodiment.

FIG. 2 illustrates a perspective view of the second member in accordance with other embodiments.

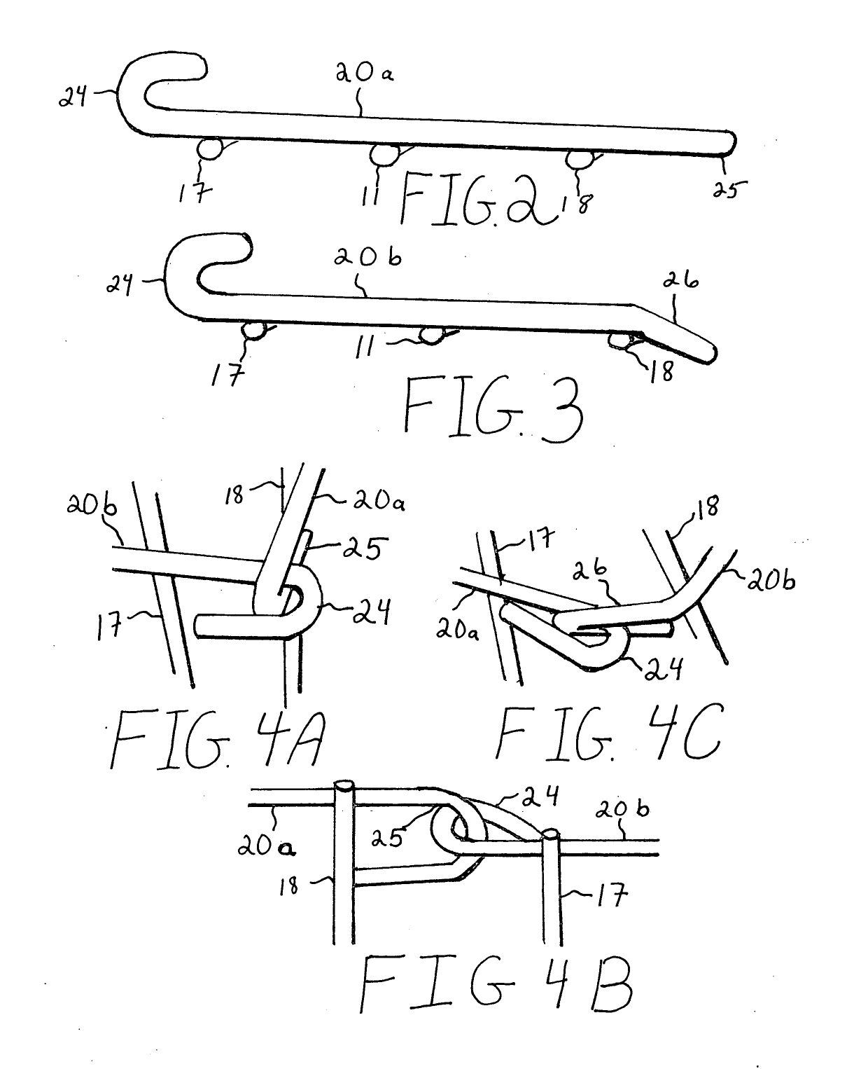

FIG. 3 illustrates a perspective view of the first member in accordance with other embodiments.

FIG. 4A-4C illustrates various aspects of first and second members in accordance with one embodiments.

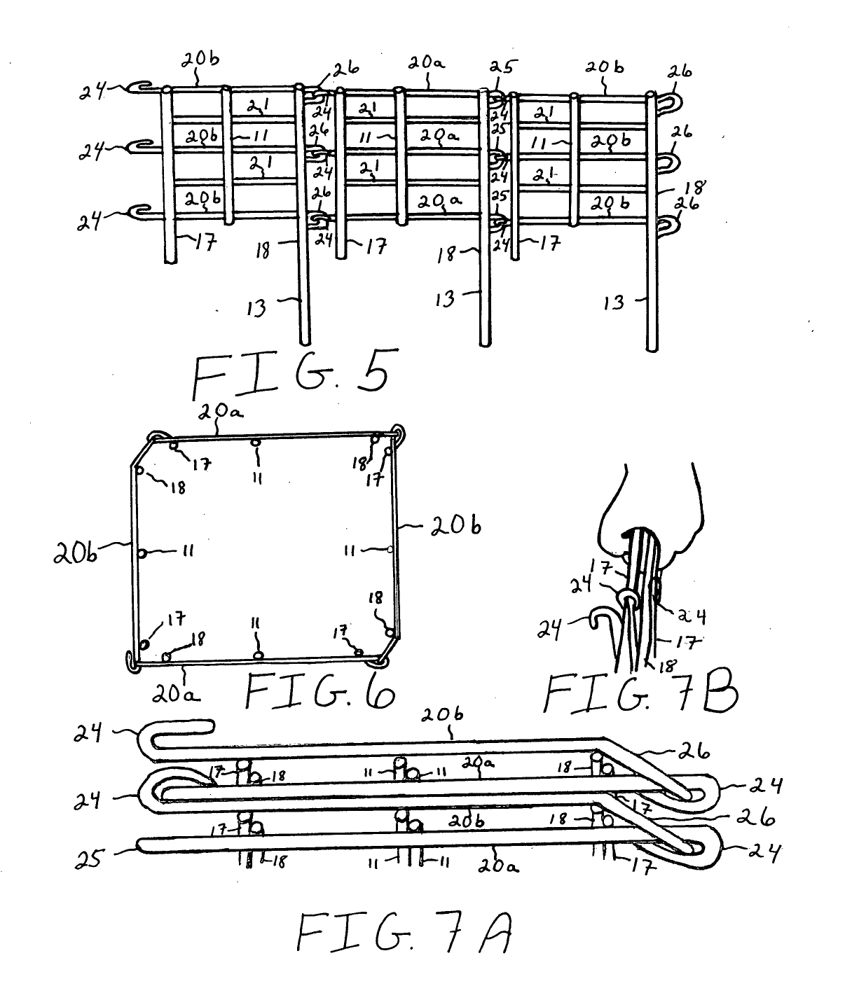

FIG. 5 illustrates panels connecting to each other in accordance with one embodiment.

FIG. 6 illustrates a perspective view of connecting member one and member two expanded in a closed state in accordance with one embodiment.

FIG. 7A-7B illustrate a perspective view of the plant support in its compacted storage state in accordance with one embodiment.

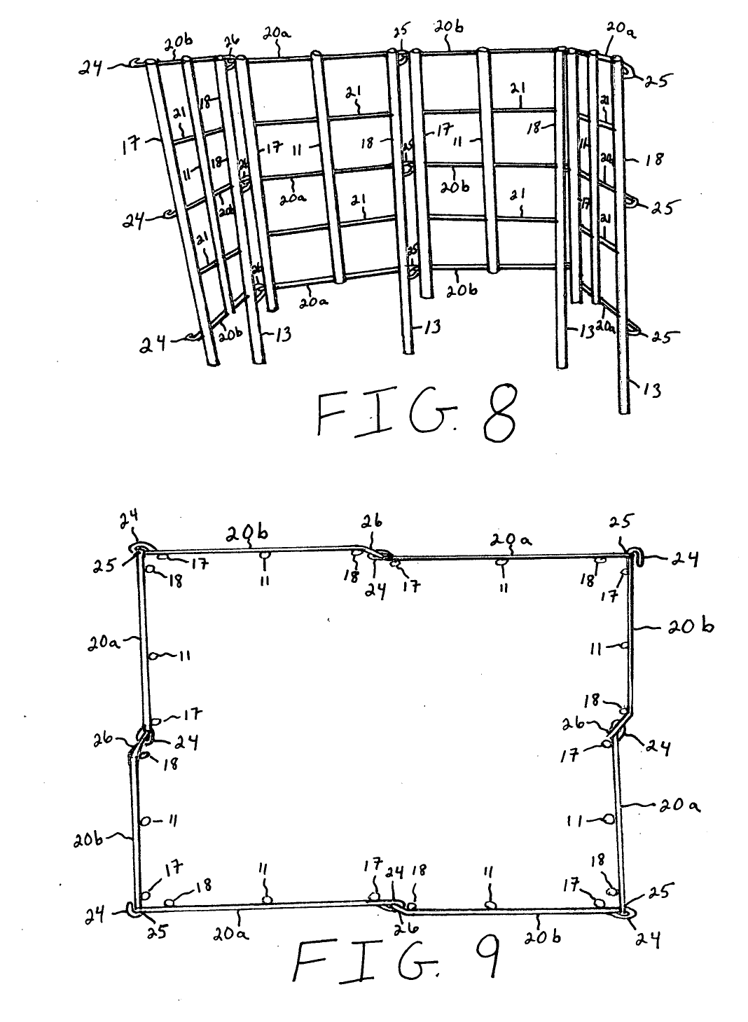

FIG. 8 illustrates encircled configuration of plant support in accordance with one embodiment.

FIG. 9 illustrates plant support connecting to a second plant support in accordance with one embodiment.

Drawing-Reference Numerals

| | |
|---|---|
| 11 | vertical member three |
| 13 | lower limb |
| 17 | side edge one |
| 18 | side edge two |
| 20a | horizontal member one |
| 20b | horizontal member two |
| 21 | horizontal member three |
| 24 | U shaped hook one |
| 25 | U shaped hook two |
| 26 | U shaped hook three |

### DETAILED DESCRIPTION

### FIGS. 1-5C—First Embodiment

During the course of this description, like numbers will be used to identify like elements according to the different figures that illustrate the invention.

(FIG. 1) illustrates a four-sided collapsible, expandable, configurable plant support comprising one embodiment, being shown in an enclosed state. However, other configurations are possible. In a preferred embodiment the plant support extends out from a compacted storage state to create support for a plant when in expanded state and a closed state. In one embodiment the plant support can configure from compacted state to a straight line to being enclosed. In a second preferred embodiment the plant support can be folded in a compact storage state and expand out for use. The plant support can be made out of a metal, such as steel, various steel alloys, or alternatively, plastic products would also work provided they were hard and durable.

In one embodiment, the plant support comprises of a plurality of panels. (FIG. 1) shows four panels. There are two styles of panels that alternate to form the plant support. In a third preferred embodiment the panels pivotally connect to each other. Additional panels can be added or reduced to change the configuration such as triangular, circular, trapezoidal, oval, and etc.

In one embodiment the panels comprise a grid of vertical and horizontal members. Each panel comprises of vertical members which cross intersecting horizontal members. Members can be connected to each other by selecting from the group consisting of: welding, soldering, molding, forming, or clipping. The quantity of members could easily be increased depending upon the nature of the plant being supported. The quantity of members can also be reduced if larger voids between the members are necessary.

In one embodiment each panel has a planar configuration having an upper edge, a base edge, and two side edges. The side edges pivotally connect to one another by select horizontal members terminating in connectors. The two styles of panels are built the same, having one major difference. The first panel has horizontal member two and the second panel has horizontal member one, each terminating in connectors.

In a preferred embodiment, (FIG. 3) shows the second horizontal member 20b extending beyond edge 17 terminating in a U shaped open hook, U shaped hook one 24. (See FIG. 4A for a closer view) Hook 24 is bent outwards from side edge one 17 but not protruding beyond edge 17. On the opposing end of hook 24, member 20b extends beyond side edge two 18 terminating in a U shaped closed hook angled a second time to the side, U shaped hook three 26. (See FIG. 4C for a closer view) Hook 26 is bent down toward edge 18 and attaches to edge 18. The angle is further compromised bending in a clockwise motion toward edge 18.

The second panel comprises first horizontal member 20a having extensions terminating in connectors. (FIG. 2) shows member 20a extending beyond edge 17 terminating in an open hook, U shaped hook one 24. (See FIG. 4A for a closer view.) Hook 24 is bent outwards from edge 17 but not protruding beyond edge 17. On the opposing end of hook 24, member 20a extends beyond edge 18 terminating in a U shaped closed hook, U shaped hook two 25. Hook 25 is bent down toward edge 18 and attaches to edge 18. (See FIG. 4B for a closer view.)

Vertical member 11 intersects the horizontal members on each panel prior to protruding beyond the edges. Member 11 can extended below 20a and 20b at the base edge. Member 11, as it is, permits easy removal of old bedding, mulch, and the like.

Edge 17 extends beyond the base edge having a length less than edge 18. Edge 17 can be extended further. In a fourth preferred embodiment keeping the extension a select length permits the panel to be secured in the ground and easily pried free. The panel is then able to move freely and independently while the remaining panels are secured in the ground. In addition, inserting the short extension into the ground allows the plant support to remain in a placed position while configured in a straight pattern, zigzag pattern, L pattern and the like. Edge 17 can be extended only to the base edge prior to protruding.

In one embodiment, edge 18 intersects the horizontal members prior to protruding the upper edge and the base edge, respectively. Edge 18 extends a select length below the base edge to form a lower limb 13, which supports the frame. In one embodiment limb 13 can be pressed into many various types of soil conditions, including dirt, sand, and clay, giving additional support. The plant support can be physically pressed into the soil by pushing down on the panels and stepping on the base edge. In addition, when limbs 13 are placed on a solid level surface, such as cement, asphalt, wood flooring, and etc., they continue to hold up the plant support. Such that the plant support can encircle a potted plant on the patio and support the plant as it grows.

Horizontal member three 21 intersects the vertical members on each panel prior to protruding beyond the edges. Member 21 can be extended beyond edges 17 and 18, respectively. Additional horizontal members can be added. The number of horizontal members can also be decreased. Horizontal members 20a and 20b can be made to attach to edges 17 and 18 without protruding, connecting panels by hinges, rings, and the like. The panels can also be connected by other variations of extensions, such as loops, D-rings, circled hooks, and the like.

In one embodiment (FIGS. 1, 4A-6) shows the panels connecting to one another. Alternate the panels beginning with the panel having member 20b, followed by the panel having member 20a. In a preferred embodiment align panels, loosely connecting them in an edge to edge relation. (See FIGS. 4B-4C.) In one embodiment continue to alternate panels until they are all connected. Edge 17 on the first panel and edge 18 of the last panel of the plant support are to be left unattached. In one embodiment (FIGS. 1,5,6,8,9) shows panels pivotally connecting to each other. The panels move individually of each other about 360 degrees. Connectors, hinges, and the like, instead of hooks, can be attached to edges 17 and 18, respectively, to allow the panels to move individually about 360 degrees. The panels can include ornate designs on and under the upper edge and base edge, and on and beside edges 17 and 18, respectively, and setting ornate designs in the center of the apparatus. The members themselves can be shaped to include a curved composition rather than straight.

### Operation—FIGS. 1, 5-8

In a preferred embodiment FIGS. 1, 5-8 feature the panels having the capability to create a wide variety of configurations. The panels can configure from a compacted storage state to a straight line to being enclosed to encircling a plant. The configurations also includes patterns such as: zigzag; L; V; oval; square; rectangular; circular; semi-circular; and etc. to support plants throughout the growing season.

In one embodiment FIGS. 7A and 7B illustrate the plant support in a compacted state. The plant support can be positioned flat accordion style in a compact storage state. To compact the panels; namely, first one swings the end panel having member 20b inwards toward next panel having member 20a. Swing the last end panel, having member 20a, outwards and then inwards towards the rest of the panels. Pull the panels together to a flattened position. (See FIG. 7A) The compacted panels can thus simply be carried in one hand (See FIG. 7B) by gripping one's hand around the members of the newly formed edge to be easily carried from location to location, easily stored, and easily expanded out.

In one embodiment FIGS. 1 and 6, the plant support is enclosed by pulling opposite end edges 17 and 18 towards each other, connecting edges 17 and 18, respectively. Glide hook 24 through hook 25, keeping hook 24 open. (See FIG. 4A for a closer view.) The plant support remains closed until the apparatus is ready to be uncoupled without the need for additional fasteners, connectors, and the like. The plant support will remain coupled even while being lifted in the air over a plant. In one embodiment, to uncouple the plant support simply glide hook 24 back through hook 25. The plant support is now ready to expand open. The apparatus may be held closed using fasteners, connectors, and the like.

In a preferred embodiment the end panel, having member 20b, can provide an opening to gain access to a plant within the enclosed apparatus by disconnecting edge 17 from edge 18 and freeing shortened extension of edge 17 from the ground. The panel can pivot on limb 13 while it is in the ground. This enables the panel to move freely such that a plant might be tended to easily without having to reach through holes, voids, and the like. When the plant support is standing on solid ground, such as concrete, asphalt, and the like, simply unhook connecting end edges. The panel having edge 17 open will automatically swing freely.

In a preferred embodiment FIGS. 1, 5, 6, 8, the method of using the plant support to support the plant is achieved in several ways:
(a) Enclose the plant support (See FIGS. 1, 6), and lift the apparatus over the plant. Set the plant support in place to provide a structure within which the plant might be grown and physically supported. Such that tomato plants, pepper plants, egg plants, and the like, can be planted first and then set the plant support in place.
(b) Configure the plant support (See FIG. 8) to encircle around the plant, expanding all the panels to position needed. Thereby, creating a support area without breaking stems and damaging fruit, flowers, and the like. Plants already established, such as a six-foot gardenia bush, can be easily supported.

In one embodiment expand the plant support (See FIG. 5) in a straight manner along side the plant. To prevent the first panel from swinging freely, insert extension of edge 17 into the soil. The plant support provides a structure wherein the plants could lean against and climb up to keep from falling on the ground. Such that peas, for example, can be grown in a straight row along side the apparatus and grow up using the plant support for support. Edge 17 can be shortened to extend to the base edge without protruding.

In one embodiment the end panel, having edge 17 disconnected, can provide a passageway to the opposite side of the apparatus by freeing shortened extension of edge 17 from the ground. The panel can pivot on limb 13 while it is in the ground. This enables the panel to move freely. Passage to the opposite side of the plant support allows plants to be easily accessed.

### FIG. 9—Additional Embodiments

Additional preferred embodiments are shown in FIG. 9; a plant support can be connected to more than one additional plant support to increase the area of support needed. Connect a second plant support by joining disconnected edge 18 of the first plant support and disconnected edge 17 of the second plant support. To enclose, join the remaining open edges to create an enclosed support area. Additional plant supports may be connected to one another to accommodate size of support area needed. Additional panels may also be added to increase size need. The combination of at least two plant supports can achieve many numerous configurations other than the ones shown from enclosing a desired area to creating a straight line.

In one embodiment disconnecting the end panel of the closest plant support creates a passageway between two connecting plant supports. Disconnect end edges 17 and 18, respectively, where the two plant supports join together. Remove edge 17 from the ground. The freed panel can pivot on limb 13 in either direction of the plant support, permitting access to plant and passage to the other side. Whereby, said plant is readily accessible and fruit, flowers, and the like can be easily harvested.

### Advantages

From the description above, a number of advantages of some embodiments of the plant apparatus become evident:
(a) Plants of all growth stages can be given support eliminating spoilage of fruit, flowers, and the like, and keep the plant itself from laying on the ground.
(b) The panels move individually to configure from a compact storage state to extend out to create support for a plant when in expanded state and a closed state.
(c) The plant support can be lifted over a plant while in an enclosed state.
(d) The end panel can be easily moved.
(e) The plant support can be expanded in an open and enclosed state permitting the usage of the device throughout the growing season and longer if needed.
(f) The end panel of the apparatus can move freely providing access to the plant while the apparatus is in an enclosed configuration.
(g) Panels can be positioned flat accordion style in a compact storage state, easily carried from location to location, and expanded out to form a plant support.
(h) The stability of the lower limbs permits usage outdoors and indoors.

### Conclusions, Ramifications, and Scope

Accordingly, the reader will see that the plant apparatus of the various embodiments can be used to support plants in all stages of growth easily and conveniently, and can be set in use without damage to the plant. Furthermore, the plant apparatus has the additional advantages:
It can be coupled to a second plant support fence to provide a greater support area;
It wraps around plants in an open state;
It couples without the need for additional fasteners, connectors, and the like;
It can be used on flat surfaces, such as concrete, asphalt, indoor flooring, and the like;
It can withstand abusive handling for years to come eliminating the need to replace year after year making the apparatus economical;
It will conform to convenient forms of manufacture, easily constructed so as to provide an apparatus that will be economically feasible, long lasting, and easily put in use; and
It has application for many uses other than originally intended.

Although the description above contains much specificity, these should not be construed as limiting the scope of the embodiments but as merely providing illustrations of some embodiments. For example, the plant apparatus can have other shapes such as triangular, circular, trapezoidal, oval, etc.; the angle extensions can be bent other degrees and shapes; the extensions can be replaced by hinges or rings which connects two panels; the enclosed state of the apparatus can be coupled by the use of fasteners, connectors, and the like.

Thus all such additional devices, methods, features and advantages be included within this description, be within the scope of the embodiments and be determined by the following claims and their legal equivalents, rather than by the examples given.

We claim:

1. An expandable, collapsible, configurable plant support apparatus, comprising:
(a) a plurality of panels having a planar configuration with an upper edge, a base edge, two side edges, and at least one lower limb, to accommodate use by a plant for support,
(b) said lower limb supporting the frame in a vertical orientation to the ground,
(c) said upper edge connecting to said side edges, said base edge connecting to said side edges, and said side edges pivotally connect to one another having the end side edge of the first panel and the end side edge of the last panel left unattached,
(d) means for joining said panel to adjacent said panel to configure from a compact storage state to extend out to create support for a plant when in expanded state and a closed state,
whereas said panels could be configured for a variety of plant support needs.

2. The panels of claim 1, wherein said panels comprising a plurality of vertical members of select length create a multitude of intersections crossing a plurality of horizontal members of select length in a grid like pattern.

3. A method of using a collapsible, expandable, configurable plant support apparatus comprising:
(a) closing the end edges of said apparatus and lifting said apparatus in an enclosed state over a plant to provide a structure within which said plant might be grown and physically supported,
(b) expanding said apparatus to encircle around established plant to give said plant support without breaking stems and damaging fruit, flowers, and the like,
whereby said apparatus can be used for support where needed throughout the growing season.

4. The method of claim 3, wherein the lower limbs of said apparatus facilitates ground penetration for additional support.

5. The method of claim 3, wherein said lower limbs support the frame in a vertical orientation to the ground, cement, asphalt, and the like, whereby said apparatus can support said plant outdoors and indoors.

6. The method of claim 3, wherein the panels of said apparatus fold accordion style in a compact storage state, whereby said panels can be easily carried from location to location, and easily put in use.

7. The method of claim 3, wherein side edges of said apparatus join adjacent side edges in a loose manner, such that said panels pivotally connect, whereby, said panels can move individually.

8. The method of claim 3, wherein end edges of the first said panel and the last said panel are left unattached.

9. The method of claim 3, wherein said panels move individually to configure from a compact storage state and extend out to create support when in expanded state and a closed state.

10. The method of claim 3, wherein said apparatus connects to second said apparatus, whereby, the area of support needed could be enlarged.

11. A method of using the end panel of a collapsible, expandable, configurable plant support apparatus, comprising:
(a) providing an apparatus of the type comprising a plurality of panels having a planar configuration with an upper edge, a base edge, at least one lower limb, two side edges, and having said panels pivotally connect to each other having the end side edge of the first panel and the end side edge of the last panel left unattached,
(b) providing an opening to gain access within said apparatus by uncoupling connecting end edges of said panel when said apparatus is in a closed state, such that a plant might be tended to easily without having to reach through said holes, voids and the like,
(c) configuring said panel sideways to gain access to the opposite side of said apparatus such that said panel allows passage for easier access to said plant,
(d) providing an opening to allow passage between at least two connecting said apparatuses by uncoupling connecting end edges of said apparatus,
whereby, said plant is readily accessible for harvesting of fruit, flowers, and the like.

12. The method of claim 11, wherein said apparatus configures an enclosed state by connecting disconnected end panels to each other, whereby, a plant could be supported within the structure.

13. The method of claim 11, wherein said end panel opens from a closed state by disconnecting said end panel from connecting end panel, such that said apparatus may be opened.

14. The method of claim 11, wherein said apparatus is capable of being positioned between a closed state and an open state.

15. The method of claim 11, wherein said apparatus is expanded in a straight like manner along side said plant to provide a structure wherein said plants could lean against and climb up to keep from falling on the ground.
